(19) United States
(12) Patent Application Publication
(10) Pub. No.: US 2026/0359773 A1
(43) Pub. Date: Nov. 12, 2026

(54) SYSTEM AND METHOD FOR PRE-DELIVERY RECEPTACLE FIT ASSURANCE

(71) Applicant: Anish Aggarwal, London (GB)

(72) Inventor: Anish Aggarwal, London (GB)

(21) Appl. No.: 19/274,492

(22) Filed: Jul. 19, 2025

Related U.S. Application Data
(60) Provisional application No. 63/803,236, filed on May 9, 2025.

(51) Int. Cl. G06Q 10/0832; G06Q 30/0601

(52) U.S. Cl. CPC G06Q 10/0832; G06Q 30/0641

(57) ABSTRACT

A system and method for pre-delivery receptacle fit assurance is disclosed, addressing failed last-mile deliveries due to parcel size incompatibility. The system integrates with e-commerce and logistics platforms to proactively assess if a parcel will fit a selected receptacle (e.g., mailbox, porch box, smart locker) before dispatch or during route planning. Core functionality includes a fit verification engine that simulates parcel orientations within the receptacle, considering dimensions, tolerances, and packaging. The system provides user-facing interfaces for customers to manage receptacle dimensions and for sellers to input product dimensions and view analytics. It also includes notification and dispatch interfaces to inform logistics providers and customers of fit status and offer alternative delivery options (e.g., locker delivery, hold-for-pickup) if a mismatch occurs. By leveraging real-time data, advanced algorithms, and continuous feedback, the invention optimizes delivery operations, minimizes error, reduces repeat attempts, and enhances customer satisfaction through secure, direct-to-receptacle delivery.

### CROSS REFERENCE TO RELATED APPLICATIONS

This patent application claims the benefit of U.S. Provisional Patent Application No. 63/803,236 filed on May 9, 2025.

### FIELD

The present invention relates generally to systems and methods for managing and verifying the compatibility of delivery items (including its packaging) with designated delivery receptacles prior to the completion of an order. More specifically, it pertains to a pre-delivery receptacle fit assurance system that enables users, logistics providers, and e-commerce platforms to assess whether a parcel or delivery item will physically fit into a selected receptacle—such as a mailbox, porch box, or smart delivery locker—based on the dimensions of both the item and the receptacle. The invention leverages real-time data collection, compatibility algorithms, and interactive user interfaces to enhance delivery accuracy, prevent failed deliveries due to size mismatches, and improve overall logistics efficiency.

### BACKGROUND

In today's booming e-commerce and delivery landscape, last-mile delivery remains a persistent and costly bottleneck. Customers frequently face the frustration of missed deliveries when items cannot be successfully delivered on the first attempt. This often happens because the recipient is not home or because there is uncertainty about whether a package will actually fit into their designated secure receiving location, like a mailbox or parcel locker. The result? Inconvenient redirects, rescheduled deliveries, or outright delivery failures, all leading to delays for customers and escalating operational costs for sellers and carriers.

A critical, yet often overlooked, contributor to this inefficiency is the absence of reliable pre-delivery fit assurance. Current delivery systems simply lack a robust mechanism to confirm whether a deliverable item, including its packaging, can fit into a customer's specific receptacle (e.g., mailbox, etc) before purchase or shipment. This uncertainty directly compromises the customer experience, erodes confidence in direct-to-receptacle delivery, and significantly drives up dissatisfaction and logistical inefficiencies. There is a clear and pressing need for a comprehensive solution that gives customers the confidence that their orders will arrive directly and securely at their receptacle, eliminating the need for their physical presence, complex re-routing, or alternative pickup arrangements.

U.S. Pat. No. 10,799,050 B1 to Glaser discloses a mailbox apparatus specifically designed for accommodating large packages. The focus is on a hardware solution with a secure chute mechanism that allows packages to drop into a protected receptacle. It provides features for easy retrieval and anti-theft functionality. This invention addresses how packages are stored, but not whether they can be delivered in the first place. It does not integrate with e-commerce platforms or provide pre-shipment verification. The current invention introduces a digital compatibility algorithm that simulates fit before dispatch, ensuring efficient delivery routes without relying on modified physical hardware.

U.S. Pat. No. 10,376,084 B2 to Hempsch et al. describes a mailbox system with a removable or modular receptacle that facilitates storage of oversized items. It provides enhanced physical adaptability to various parcel sizes. While this prior art allows mailboxes to physically adjust to different parcel sizes, it requires user-side or postman-side intervention. There is no integration with logistics systems or preemptive analysis. The present invention, on the other hand, uses digital pre-checks that optimize delivery even before a parcel leaves the warehouse.

U.S. Pat. No. 7,256,691 B2 to Awobue introduces a “smart mailbox” equipped with sensors to detect whether a parcel has been delivered and notify users accordingly. It includes mechanisms like weight sensors or motion detectors to alert users post-delivery. This patent's “smart” functionalities are post-event based-focused on notification after an item is placed. In contrast, the current invention offers pre-event intelligence, determining in real-time if a parcel will even fit based on dimensional simulations, and guides decision-making before shipment.

United States Patent Publication No. 2017/0105564 A1 to Galluzzi discusses detection mechanisms to identify parcel delivery using electronic sensors, primarily to confirm presence or absence of items in a mailbox. This invention deals only with event detection and status indication, not proactive delivery planning. The current invention's uniqueness lies in preventing failed deliveries altogether by simulating real-world package orientations and mailbox capacities before any logistics action.

U.S. Pat. No. 6,659,337 B2 to Woelfel focuses on physical indicators (manual or semi-automatic flags) to show whether mail has been delivered. It is a purely mechanical solution. The current invention offers digital, data-driven intelligence integrated with modern logistics software. It has no dependency on manual operation and operates autonomously through dimensional databases.

The present invention addresses this critical gap by introducing a preemptive receptacle compatibility verification system. Using the known internal dimensions of a recipient's mailbox or parcel locker and the dimensions of the parcel (available during the packing or shipping stage), the system automatically determines whether the parcel can be securely deposited. The system further enhances accuracy by considering different parcel orientations, clearance tolerances, and packaging configurations to improve fit prediction.

This empowers shippers and e-commerce platforms to proactively manage delivery routes and packaging, and also enables customers to make informed decisions during checkout—such as opting for smaller packages, in-store pickup, or alternate delivery addresses. The system integrates seamlessly with logistics platforms and e-commerce APIs, transforming receptacle fit-checking from a manual, post-facto concern into an automated and intelligent pre-delivery assurance step.

### SUMMARY

The present invention relates to systems and methods for verifying package-to-receptacle compatibility in advance of parcel dispatch or delivery. Specifically, the invention provides a novel software-integrated solution for assessing whether a package will fit into a designated delivery receptacle based on known or inferred dimensional data. This verification occurs prior to shipment or during delivery route planning, thereby reducing the incidence of failed delivery attempts, improving last-mile efficiency, and enhancing user satisfaction in e-commerce logistics.

In one embodiment, the invention includes a software-based system integrated with logistics management platforms or e-commerce order processing systems. Upon generation of an order, the system retrieves or receives the dimensions of the product packaging, including height, width, depth, and optionally, its weight. Concurrently, the system accesses a stored database containing dimension profiles of recipient receptacles. These receptacle dimensions may be provided at account creation, obtained via customer input, or inferred from geographic or housing profile databases.

The core functionality of the system is a fit verification engine that algorithmically simulates multiple orientations of the parcel with respect to the internal space of the recipient's receptacle. This engine evaluates not only whether the parcel can be inserted in its current orientation, but also whether rotation along one or more axes allows for a successful fit. The simulation may be performed in 3D space using bounding-box geometry or advanced placement heuristics.

If the simulation concludes that the package will fit securely in the receptacle, the item is cleared for dispatch to the receptacle. If it determines a mismatch, the system may necessitate a user decision by prompting for alternative fulfillment protocols such as locker delivery, hold-for-pickup designation, or enabling selection of an alternate pre-registered receptacle. This logic may also be presented to the customer at checkout, warning them of potential delivery constraints or suggesting alternate delivery addresses.

An optional enhancement to the system involves AI-based predictive modeling to account for receptacle obstructions, irregularities, or shared space usage in apartment complexes. Additionally, the system may integrate with delivery personnel apps or handheld scanners to re-confirm receptacle status during delivery using augmented reality or manual override prompts.

In another embodiment, the invention includes a user-facing interface allowing customers to register or update the dimensions of their receptacle. This ensures data accuracy and improves fit assessment. Users may also view prior fit results, adjust preferences for alternative delivery methods (e.g., deliver to a different receptacle, with a neighbour), etc.

The invention also supports data analytics and learning mechanisms, whereby historical delivery results are used to refine prediction models. For example, if a particular packaging type repeatedly results in failed receptacle fits, the system may recommend preemptive alternatives for future deliveries of similar items.

Overall, the invention introduces a unique combination of dimensional intelligence, logistics integration, and proactive decision-making. It is platform-agnostic, capable of integration with various courier systems, postal networks, and e-commerce platforms. It optimizes delivery operations, minimizes human error, reduces repeat attempts, and mitigates the risks associated with parcel theft and exposure to environmental conditions.

In conclusion, the present invention addresses a longstanding problem in the last-mile delivery ecosystem through a preemptive, intelligent verification system. It shifts the paradigm from reactive delivery failure management to proactive compatibility assessment, setting a new standard in smart logistics and consumer fulfillment technology.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Reference will now be made to the accompanying drawings showing example embodiments of this disclosure. In the drawings:

FIG. 1 shows, in block diagram form, an example system using a pre-delivery receptacle fit assurance system;

FIG. 2A illustrates an example user interface enabling sellers to add new products;

FIG. 2B illustrates an example dashboard user interface for pre-delivery receptacle fit assurance, providing real-time validation and historical parcel-to-receptacle fit analysis for sellers;

FIG. 2C illustrates example fit failure report tables, providing a structured overview of parcel fit discrepancies and delivery challenges;

FIG. 3 illustrates an example user interface for a customer to manage receptacles;

FIG. 4 illustrates an example user interface for a user checkout process, specifically demonstrating the integration of pre-delivery receptacle fit assurance status within delivery options.

FIG. 5 is a data flow diagram of an example pre-delivery receptacle fit assurance system in accordance with an example embodiment;

FIG. 6 is a flow diagram of an example method for using a pre-delivery receptacle fit assurance system.

### DETAILED DESCRIPTION

Additional features and advantages of the invention will be set forth in the description that follows and, in part, will be obvious from the description or may be learned through the practice of the invention. These and other features of the present invention will become more fully apparent from the following description or may be appreciated through the implementation of the invention as set forth hereinafter.

This detailed description refers to the included drawings. You'll notice the use of the same reference numbers across the drawings and the text to point to identical or similar parts, making it easier to follow along. Essentially, the detailed description that follows is an example meant to explain the concepts, not to limit them. The actual, precise scope of the invention is defined solely by the appended claims. For the sake of clarity and to ensure the core aspects of the disclosed embodiments remain prominent, comprehensive elaboration on well-known methods, procedures, or components has not been provided.

The present invention discloses a pre-delivery receptacle fit assurance system (referred to hereinafter as “the system”) that ensures an item scheduled for delivery will physically fit within a recipient's designated delivery receptacle, such as a mailbox, package drop box, or other secure container, before the item is dispatched. This preemptive validation is designed to reduce failed deliveries, increase logistic efficiency, and enhance customer satisfaction in both residential and commercial delivery contexts.

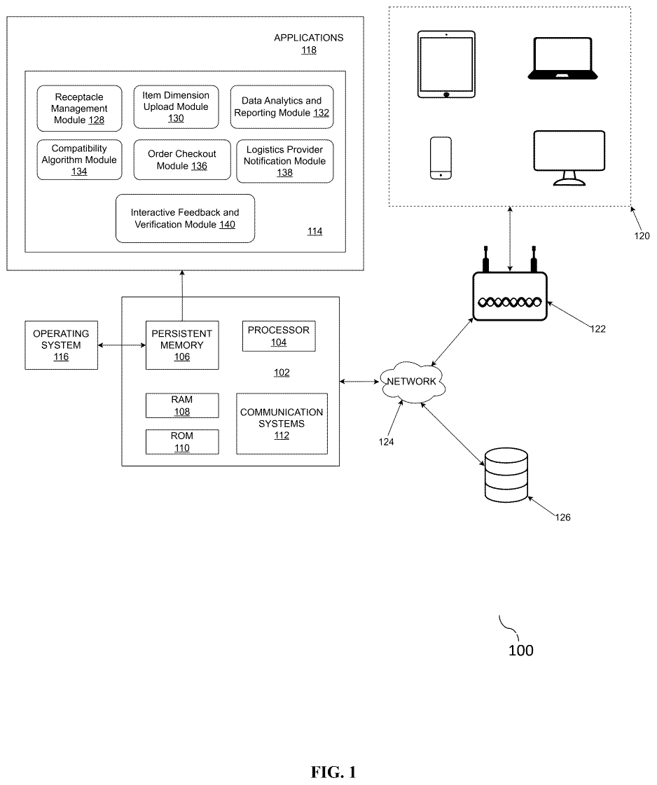

Reference is now made to FIG. 1, which shows, in block diagram form, an example system 100 for implementing a pre-delivery receptacle fit assurance system to assure that items fit into designated delivery receptacles before placing an order. The system, referred to as System (100), comprises various components that work cohesively to achieve this objective, with flexibility to adapt the arrangement, components, and methods as needed to accommodate diverse implementations, including but not limited to those described herein, as well as future advancements in technology and processes.

At the core of System (100) is the pre-delivery receptacle fit assurance server (102), which may be implemented in various forms, including but not limited to a general-purpose computer, server, mainframe, distributed computing system, cloud-based infrastructure, or any combination thereof. The server includes a controller with at least one processor (104), such as, without limitation, a microprocessor, system-on-chip, or other processing units, responsible for overseeing the system's operations. The processor may comprise a single processing unit or multiple processing units working in coordination to execute computer-readable program instructions. These instructions are stored in tangible non-transitory computer-readable storage media, such as, for example, persistent memory (106), which may include, but is not limited to, a flexible disk, hard disk, CD-ROM, solid-state drive, or other storage technologies. Additionally, instructions may reside in read-only memory (ROM) (110), utilizing technologies such as, without limitation, programmable read-only memory (PROM), electrically erasable programmable read-only memory (EEPROM), Flash memory, or other memory types. Random access memory (RAM) (108) supports active data processing, while a communication system (112) enables connectivity with external devices and networks through various protocols and interfaces, including but not limited to wired, wireless, or hybrid communication technologies.

System (100) connects to client devices (120), such as, without limitation, laptops, desktop computers, or other computing devices, via a wide area network (WAN) (124), such as the Internet or other network types. Client devices run applications, including but not limited to web browsers or dedicated applications, to interact with the pre-delivery receptacle fit assurance server (102). The server delivers a user-friendly fit assurance interface, which can be rendered on the server and transmitted to the client device for display or sent as data for local rendering on the client device. The interface supports diverse input methods, such as, for example, manual entry, image uploads, with the capability to integrate additional input methods.

Mobile devices such as smartphones, tablets, or other portable devices, further extend system access. These devices support communication through various means, including but not limited to cellular networks, Wi-Fi via wireless access points (122) adhering to standards such as IEEE 802.11, or hybrid communication methods. Mobile devices enable users to manage receptacle details, receive real-time notifications, modify delivery preferences, provide delivery feedback on the go, and SMS-based inputs for low-tech users with support for additional connectivity options as needed.

The system interfaces with one or more data repositories (126), accessible through network (124), which store critical information, including but not limited to customer receptacle dimensions, item dimensions, fit assurance results, delivery instructions, user and delivery partner feedback, and historical analytics data. Data repository (126) employs robust security measures, such as, for example, encryption for stored data and secure authentication protocols for access control, with the flexibility to incorporate additional storage methods, data types, or security protocols. It supports efficient data management, enabling the system to retrieve and update information as needed while respecting user privacy preferences, such as opting out of photograph storage.

The server hosts software modules (114), stored in persistent memory (106), which include operating system software (116) to manage server operations and software applications (118) to provide specialized functionality, among other possible software components.

The software applications (118) of the server are modular and extensible. Key modules include the Receptacle Management Module (128), the Item Dimension Upload Module (130), the Data Analytics and Reporting Module (132), the Compatibility Algorithm Module (134), Order Checkout Module (136), the Carrier/Logistics Provider Notification Module (138), and the Interactive Feedback and Verification Module (140). These modules may operate independently yet fully interconnect to constitute a seamless and comprehensive end-to-end system.

The Receptacle Management Module (128) is a critical component of the pre-delivery receptacle fit assurance system (100), responsible for enabling users to register, manage, and maintain accurate data about one or more delivery receptacles associated with their addresses. This module provides an intuitive, user-friendly interface accessible via web browsers, mobile applications, or other connected devices, allowing users to input detailed attributes of their delivery receptacles. These attributes include but are not limited to the physical dimensions (length, width, height), shape (e.g., rectangular, cylindrical, trapezoidal), material conditions (e.g., weatherproof, insulated, fragile), location identifiers (e.g., front porch, rear gate, lobby box), and constraints such as maximum allowable weight or restricted access times. Users can associate multiple receptacles with a single account—for instance, linking home and work addresses—or designate a priority order for receptacle preference. This module supports manual data entry via structured input fields, but it also incorporates advanced technologies such as image-based dimension estimation, which uses computer vision to analyze uploaded photos and automatically detect receptacle boundaries and dimensions. Additionally, the system is designed to interface with IoT-enabled smart receptacles, which can autonomously transmit real-time dimension and status data (e.g., fullness level, temperature, or lock state) back to the server. Through this module, users can upload photographs of their receptacles for verification and record-keeping, or use augmented reality (AR) tools through mobile devices to visually measure receptacles on-screen by tracing outlines. All data entered or captured is stored in a secure data repository (126) and can be updated at any time by the user to reflect changes, such as replacing a mailbox or adding a new delivery box. The Receptacle Management Module is designed for scalability and can accommodate residential users, businesses with multiple delivery zones, or even shared/community receptacles. Importantly, this module not only supports the initial fit assurance process but also serves as a persistent, dynamic profile that continuously informs the Compatibility Algorithm Module each time a new delivery is initiated. Privacy controls are embedded into the module, allowing users to opt out of sharing specific types of data (e.g., photos), while maintaining the integrity of the fit assurance process.

The Item Dimension Upload Module (130) is specifically tasked with collecting, validating, and managing data of items intended for delivery. This module ensures that the system has accurate and up-to-date item details, measurements—such as length, width, height, volume, weight, and shape characteristics—necessary for evaluating whether a given item can be accommodated within a designated delivery receptacle. The module supports multiple data acquisition pathways, designed to accommodate the diverse operational environments of e-commerce platforms, fulfillment centers, and logistics providers. Among the primary methods is the automated data ingestion from fulfillment centers, where advanced technologies such as barcode scanning, RFID tagging, 3D optical scanners, and augmented reality (AR)-enabled imaging are used to capture item dimensions during the picking, packing, or staging processes. For logistics partners or small-scale retailers lacking such infrastructure, the module also allows manual entry of item dimensions via a secure input interface, supplemented by drop-down menus and data validation tools that minimize human error. The system implements robust error-checking mechanisms, including real-time validation against centralized product databases, historical delivery data, and intelligent machine learning-based anomaly detection that flags suspicious entries—such as inconsistencies between product weight and size, or known standard packaging deviations.

Furthermore, the module (130) may expose functionality to update item or parcel dimension data during transit. For example, if an item is compressed (in the case of flexible packaging), repacked, or damaged during handling, edge device scanners or smart packaging sensors integrated with the logistics chain can feed updated size and shape information back into the system. This ensures that the fit assurance calculation remains accurate up to the final mile of delivery. To maintain system flexibility, the Item Dimension Upload Module may support integration with third-party inventory systems, warehouse management systems (WMS), and carrier APIs, using industry-standard protocols such as RESTful APIs, EDI, or MQTT. Data gathered by the module is stored securely in the central data repository (126), tagged with unique item identifiers, timestamps, and audit trails to facilitate tracking, future reference, or dispute resolution. By maintaining a comprehensive and validated item dimension database, the module plays a foundational role in enabling the Compatibility Algorithm Module (134) to provide real-time, accurate fit assurance decisions to users. In summary, the Item Dimension Upload Module ensures the integrity, accuracy, and adaptability of item data within the system, making it indispensable to the overall success of the delivery fit assurance process.

The Compatibility Algorithm Module (134) is the core computational engine of the pre-delivery receptacle fit assurance system (100), responsible for both determining the optimal packaging configuration for items and verifying its physical and functional fit into a user-designated delivery receptacle. This module receives item dimensional data (e.g., length, width, height, volume, shape descriptors) from sources such as data repositories (126) and accesses receptacle dimensions and attributes (e.g., access angles, irregular shapes, non-locking door dimensions) from the data repositories (126).

To determine optimal packaging, the module (134) employs a suite of advanced computational algorithms, including but not limited to, Volume Fitting Algorithms for precise spatial optimization, Cost Optimization Logic to balance economic efficiency, etc to generate a highly detailed, actionable optimal packaging solution.

For fitment verification, the module 134 compares the determined parcel dimensions against the receptacle's characteristics, factoring in tolerance thresholds, receptacle access angles, and special constraints such as irregular shapes (e.g., cylindrical, tapered, or L-shaped containers). The algorithm accounts not only for rigid spatial matching, but also applies logic for flexible packaging, evaluating whether compressible or malleable items (such as padded mailers or soft goods) might conform to available space even if rigid dimensions slightly exceed the receptacle's nominal limits. To enhance realism and accuracy, the algorithm incorporates 3D geometry modeling and spatial simulation techniques, allowing it to digitally “place” the item into a virtual model of the receptacle, simulating fitting sequences, rotation allowances, and entry paths. Environmental and functional constraints such as weatherproofing requirements, receptacle orientation (vertical vs. horizontal), or door size limitations are also factored into the assessment to ensure practical deliverability, not just theoretical fit.

The Order Checkout Module (136) is designed to seamlessly integrate the pre-delivery receptacle fit assurance system's capabilities into an e-commerce platform's final purchasing journey. This module acts as the user interface point where the output from the Compatibility Algorithm Module (134)—such as real-time fitment assessments (e.g., “√ This item fits your mailbox” or “ [symbol] Item too large for selected receptacle”)—is displayed to the customer. It enables users to review the fit status for their chosen items against their designated receptacles, select alternative receptacles, or opt for alternative delivery methods if a mismatch is detected. Furthermore, the Order Checkout Module (136) facilitates the final placement of the order, transmitting relevant data to downstream modules like data repositories (126) and the Carrier/Logistics Provider Notification Module (138) immediately upon transaction confirmation, ensuring that validated packaging data, delivery instructions, and receptacle identifiers are transmitted in real-time to the fulfillment or carrier systems.

The Carrier/Logistics Provider Notification Module (138) is a communication-focused subsystem within the pre-delivery receptacle fit assurance system (100), engineered to ensure that delivery personnel and logistics networks are fully informed about item receptacle compatibility outcomes and associated delivery instructions. This module functions by seamlessly interfacing with external carrier systems through standardized protocols—such as RESTful APIs, XML/EDI feeds, or secure webhook callbacks—to deliver real-time fit assurance results and specific delivery directives tailored to each shipment. Once the Order Checkout Module (136) stores information about parcel delivery to a receptacle in data repositories (126) whether a package fits the intended receptacle, Notification Module (138) pushes that information to the logistics provider's backend systems or driver handheld devices. For example, if an item is confirmed to fit the recipient's primary mailbox, the module can transmit a directive stating “Place in mailbox at front porch, right side,” including geo-tagged receptacle locations or photographic references if provided by the user. Conversely, if an item is too large, the system may automatically communicate alternative instructions such as “Leave at designated secondary box behind gate,” “Hold for pickup,” or “Deliver to neighbor's receptacle (user approved).”

The module is designed for bidirectional communication, enabling carriers not only to receive instructions but also to send delivery confirmation, exception notices, or fit mismatch reports back to the system. This is especially useful when unforeseen on-site issues arise—such as blocked access to the designated receptacle or the discovery that a receptacle has been damaged or removed—allowing the system to immediately notify the user and offer dynamic redirection options. By leveraging carrier mobile apps, vehicle-mounted devices, or smart lockers, the system ensures that the correct, context-aware information reaches the delivery staff at the moment of decision. The module also maintains delivery partner-specific preferences, adapting the formatting and delivery method of instructions based on each provider's integration capability, service level agreements, and jurisdictional practices. In addition, the module may support delivery route optimization inputs, aligning receptacle fit assurance results with logistical planning software to avoid failed delivery attempts and reduce route inefficiencies. The design emphasizes security and reliability, incorporating authentication protocols, data encryption, and logging mechanisms to preserve data integrity and compliance with privacy regulations. Overall, the Carrier/Logistics Provider Notification Module is critical in translating intelligent fit assessments into actionable, real-world logistics outcomes, ensuring last-mile delivery precision while minimizing disruptions and enhancing the overall customer experience.

The Interactive Feedback and Verification Module (140) is designed to close the loop between delivery predictions and real-world outcomes. This module empowers both customers and logistics personnel to provide real-time feedback on the actual delivery experience, particularly focusing on whether a parcel fits into the designated receptacle as predicted by the system. Accessible through various interfaces—including mobile apps, web portals, SMS-based platforms for low-bandwidth users, and delivery personnel handheld devices—this module allows users to confirm successful deliveries, report discrepancies (e.g., parcel did not fit as assured, receptacle was inaccessible, item was damaged during forced fitting), and suggest updates to receptacle data or fit assumptions. It may support multimedia inputs such as photographs or voice notes to enhance the accuracy and richness of feedback. This feedback is then processed and logged within the system's data repositories, where it becomes a critical input for refining the Compatibility Algorithm Module (134) and enhancing future prediction accuracy. Additionally, the module includes built-in response workflows—such as automated apologies, compensation options, or prompts to update receptacle information—to ensure a responsive and customer-centric experience. It may also facilitate issue resolution with delivery carriers by forwarding detailed incident logs, including timestamps, GPS data, and feedback content. The system supports both structured feedback (e.g., rating scales, checkboxes) and unstructured comments, allowing for comprehensive issue reporting. Through continuous collection and integration of real-world validation data, the Interactive Feedback and Verification Module (140) helps establish trust in the fit assurance system, enables continuous improvement through adaptive learning, and ensures accountability across all stakeholders in the delivery chain.

The Data Analytics and Reporting Module (132) is designed to collect, process, and present data related to system performance, user behavior, and operational metrics in a meaningful and actionable format. This module aggregates information from various subsystems—including receptacle dimension records, item fit assessment results, user feedback logs, and carrier interaction data—to generate comprehensive analytics dashboards and reports. These outputs may include, for example, success and failure rates of fit assurance predictions, frequency of item-receptacle mismatches, average receptacle dimensions across geographic regions, most commonly used receptacle types, delivery rerouting rates, and historical trends over time. The module supports both real-time and periodic data processing, enabling dynamic visualization of metrics through intuitive graphical interfaces. It is equipped with customizable filters and drill-down capabilities, allowing users such as logistics providers, system administrators, or e-commerce partners to segment data by criteria like time period, location, product category, or carrier. Additionally, the module may employ machine learning or statistical analysis to identify anomalies, forecast peak delivery loads, and optimize delivery routing strategies. Security and privacy are preserved through access-controlled views and encrypted data handling, and the module can export reports in various formats (e.g., CSV, PDF, API output) for integration into third-party business intelligence platforms. Designed with flexibility in mind, the Data Analytics and Reporting Module (132) is extensible to accommodate future metrics, adapt to evolving regulatory requirements, and support decision-making across technical and business stakeholders.

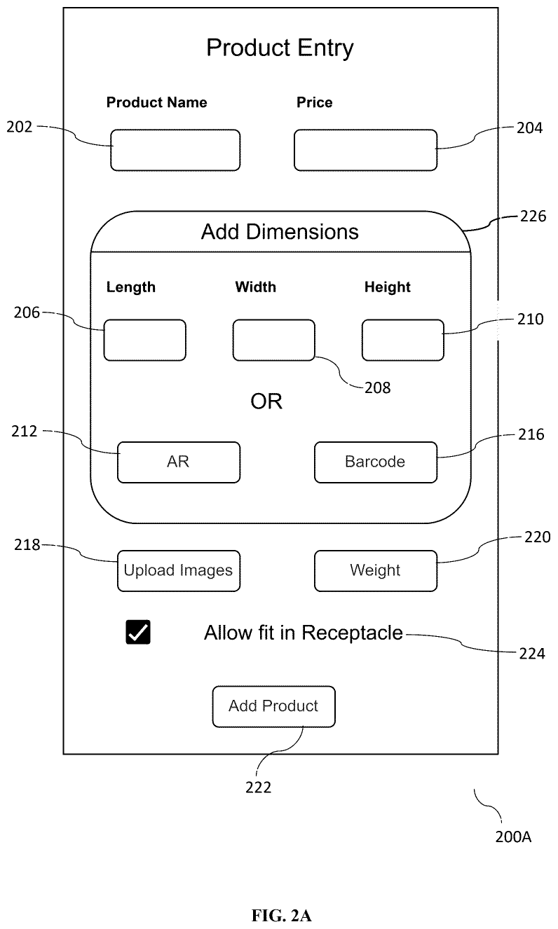

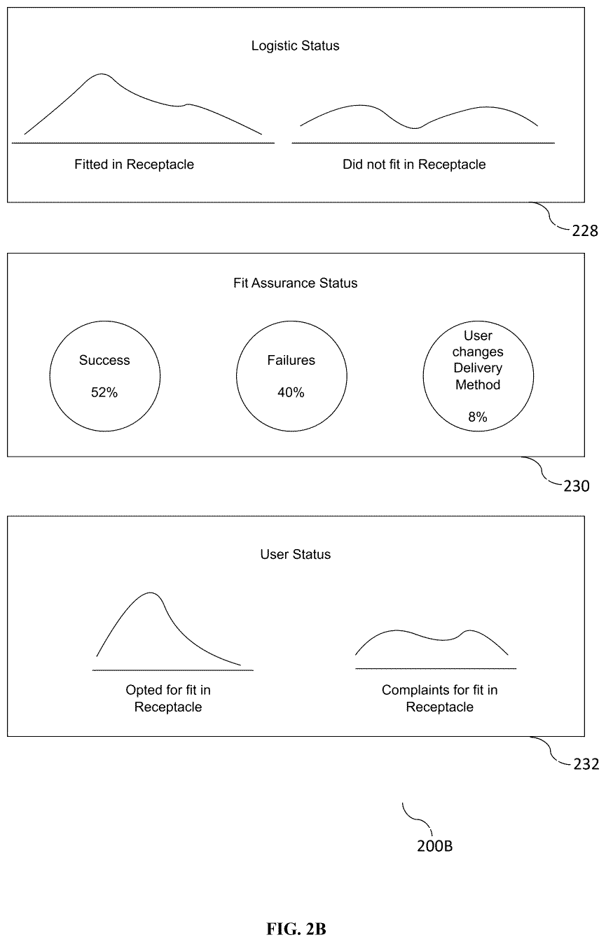

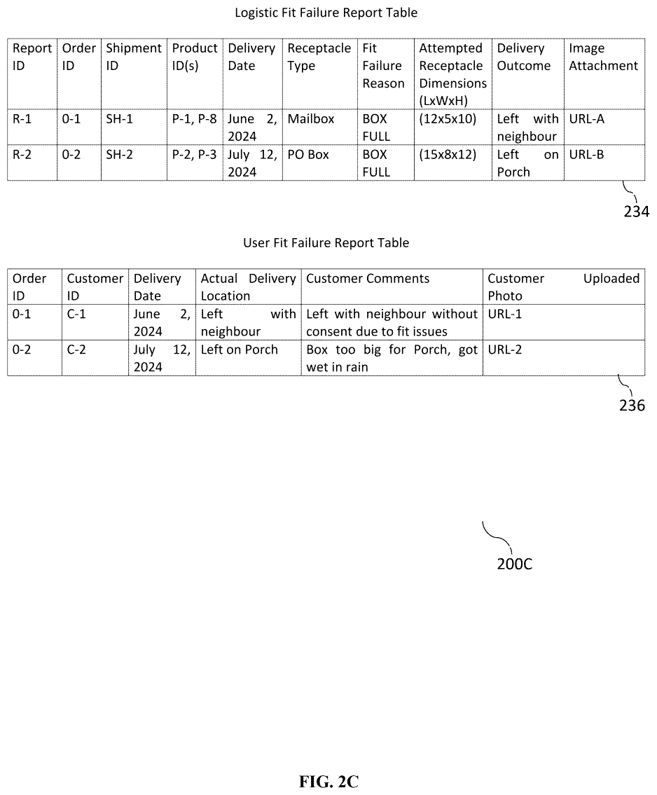

Reference is now made to FIG. 2A, FIG. 2B, and FIG. 2C, which collectively represents the seller dashboard interface of the pre-delivery receptacle fit assurance system. These figures illustrate how sellers interact with the platform to manage product data (e.g., dimensions, images, weight, etc), analyze historic parcel-to-receptacle compatibility, and receive real-time fit assurance feedback.

FIG. 2A illustrates an example user interface for product entry (200A) to input product information essential for the pre-delivery receptacle fit assurance system. This interface streamlines the input of fundamental product details, including: Product Name (202) and Price (204) allow the seller to specify the basic identity and cost of the item being listed for sale. The interface provides flexible methods for capturing dimensional attributes within the Add dimensions section (226): such as manual entry of Length (206), Width (208), and Height (210) or advanced automated options like AR scanning (212) and Barcode scanning (216) to ensure high precision and reduce manual error. These dimensions are essential for the system to assess whether the item, once packaged, will fit in a designated receptacle (e.g., mailbox, locker, etc). The interface may contain additional input fields such as the Upload Images button (218) allowing sellers to include product images—possibly for verification, AI-based measurement, or customer reference—and the Weight field (220) to enter the product's mass, which could be relevant for both shipping logistics and packaging optimization. A key element of the interface is a checkbox labeled “Allow fit in Receptacle” (224) that enables the seller to designate whether this specific product is eligible for delivery into a recipient's designated receptacle. When selected, this preference informs the system's fit assurance algorithms and subsequent logistical planning, indicating that receptacle delivery is a permissible or desired option for this item. Once all information is entered, the seller can click the Add Product button (222) to save the data and integrate the product into the broader fit verification workflow. Overall, FIG. 2A showcases a highly functional and modular interface that seamlessly integrates into pre-delivery receptacle fit assurance system, empowering sellers to contribute directly to optimized last-mile delivery, and enhances customer satisfaction.

FIG. 2B illustrates an example real-time results dashboard (200B), providing sellers with detailed analytics on the performance of the pre-delivery receptacle fit assurance system. This interface enables sellers to understand how packages are performing in relation to user receptacles (such as mailboxes or parcel lockers), offering insight into operational success, logistical challenges, and customer behavior. This interface presents key operational metrics across distinct panels, each presenting a specific category of metrics.

The Logistic Status panel (228) displays successful parcel fits in receptacles versus failures, visualizing compatibility trends allowing for an intuitive understanding of package compatibility over time or across different product categories. The presented data may be visualized via line charts or distribution curves, offering sellers intuitive understanding of package compatibility trends across time or product types.

The Fit Assurance Status panel (230) presents core validation outcomes, providing a clear breakdown. For example: “Success: 52%”, indicating that more than half of the deliveries were confirmed to fit in receptacles, based on pre-shipment fit assurance, “Failures: 40%” reflects packages that failed to meet the fit criteria, either due to inaccurate dimension entry, inappropriate packaging, or an unforeseen mismatch with the recipient's receptacle. Additionally, “User changes Delivery Method: 8%” captures how many users proactively selected a different delivery method (e.g., locker pickup or store drop-off) after being informed that their package wouldn't fit. This panel offers direct insights into the system's predictive accuracy and its influence on user behavior regarding delivery preferences.

Furthermore, the User Status panel (232) gives a glimpse into customer engagement and satisfaction. It includes a chart indicating how many users “Opted for fit in Receptacle,” which demonstrates the system's adoption and user trust in the assurance model and the volume of “Complaints for fit in Receptacle,” likely referring to cases where the system predicted a fit, but the item did not successfully fit in practice—highlighting areas for system improvement or seller oversight.

Collectively, FIG. 2B equips sellers with actionable and data-driven feedback in real time, empowering them to continuously refine packaging strategies, proactively troubleshoot potential fulfillment issues, and significantly enhance both last-mile delivery efficiency and overall customer satisfaction

FIG. 2C, illustrates example fit failure report tables (200C) designed to provide sellers a transparent overview of instances about failed parcel-to-receptacle fit attempts based on the feedback collected from logistics and customers. These tables provide a comprehensive diagnostic tool for identifying patterns, pinpointing issues, and improving future packaging and delivery outcomes. This figure comprises a Logistic Fit Failure Report Table (234), which aggregates data about parcels that failed to fit into the designated receptacle during the delivery process, based on information provided by shipping personnel. Each row within the Table (234) documents a specific failed delivery instance. The table may include comprehensive columns for tracking the Report ID, associated Order ID and Shipment ID, the specific Product ID(s), Delivery Date, the designated Receptacle Type, and the precise Fit Failure Reason. It further details the Attempted Receptacle Dimensions (L×W×H), the actual Delivery Outcome, and provides an Image Attachment link for visual verification. For example, in the first row (R-1), a shipment intended for a receptacle failed due to the receptacle being full, despite the attempted parcel size being 12×5×10 inches resulting in the package being instead left with a neighbor, and an image (linked via “URL-A”) was attached to verify the scenario. The second row (R-2) documents a similar failure involving a PO Box, with the package ultimately left on a porch with its supporting image ‘URL-B’.

Complementarily, the User Fit Failure Report Table (236) captures customer-side complaints and feedback related to fit assurance breakdowns. This table includes fields for Order ID, Customer ID, Delivery Date, Actual Delivery Location, Customer Comments, and corresponding photos uploaded by the Customer highlighting the issue. These entries highlight real-world dissatisfaction, such as unauthorized changes in delivery method or packages being damaged due to improper placement. For example, in one entry, a customer (C-1) reported that a package was left with a neighbor without consent due to fitting issues, while another (C-2) noted that a box too large for the porch was left in the open and got wet from rain. These complaints are linked with corresponding image evidence via URLs (e.g., URL-1, URL-2), allowing the seller or delivery service to verify and analyze what went wrong.

Together, the Logistic Fit Failure Report Table (234) and the User Fit Failure Report Table (236) in FIG. 2C forms a comprehensive feedback loop for the pre-delivery receptacle fit assurance system. Table (234) provides objective, system-logged fit failure data (e.g., “BOX FULL”), while Table (236) delivers subjective user feedback (e.g., “Box too big for Porch, got wet in rain”), collected via surveys or forms and stored in a data repository (e.g., data repositories (126) or Tracking Database 502). This integrated view enables sellers and logistics partners to identify recurring patterns, pinpoint root causes of failure, and implement corrective actions like revising packaging standards or adjusting delivery preferences, ultimately improving the pre-delivery receptacle fit assurance system.

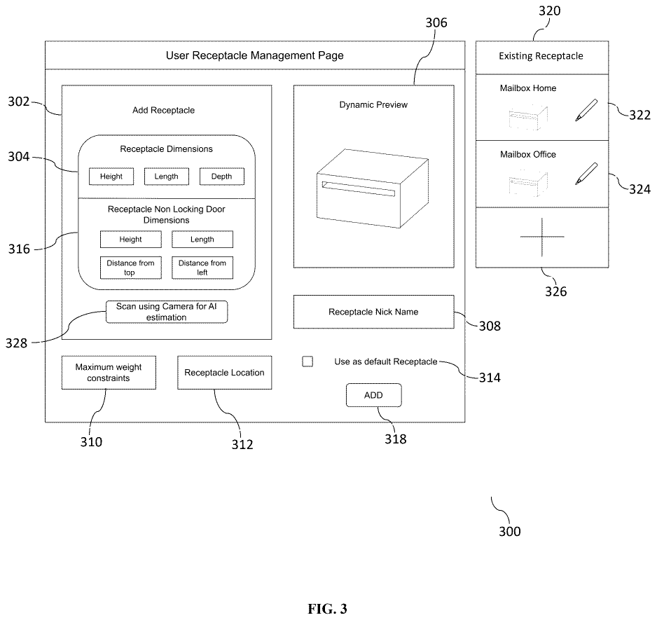

FIG. 3 illustrates a user-facing interface—User Receptacle Management Page (300) empowering users to input, configure, edit, and manage multiple delivery receptacles (e.g., home mailboxes, office parcel lockers) within the parcel fit assurance system.

The interface features an Add Receptacle section (302) where users can manually define precise Receptacle Dimensions (304), including height, length, and depth, crucial for backend fit validation. The interface may also feature a section to provide the dimensions of the Non-Locking Door of the Receptacle (316), where users provide dimensions of the door or opening through which packages must pass. This section includes door height and length, along with additional optional inputs like distance from the top and distance from the left, helping to model mail slots or partial openings accurately. Users can also leverage a “Scan using Camera for Al estimation” button (328) for automated dimension capture via computer vision or augmented reality, enhancing accuracy for complex shapes.

Additional fields allow for input of Maximum weight constraints (310), the Receptacle Location (312) (e.g., “front porch,” GPS-enabled address), and a customizable Receptacle Nick Name (308) (e.g., “Mailbox Home”). A “Use as default Receptacle” checkbox (314) enables designation of a primary delivery location.

Once a user has provided adequate fields, a Dynamic Preview window (306) may provide a real-time visual rendering of the receptacle based on the user's input. This can help users visualize the receptacle and catch any errors in measurement before saving it, improving both accuracy and user confidence in the process. When all the fields are filled out, the user can click the “ADD” button (318) to submit the new receptacle to their profile.

An Existing Receptacle section (320) presents a list of previously added receptacles, with individual nicknames (e.g., Mailbox Home (322) and Mailbox Office (324)), thumbnails and edit functionalities. A plus icon (326) further facilitates the addition of more receptacles, supporting multi-location delivery preferences (such as alternating between home and work addresses).

In summary, FIG. 3 provides users with a powerful yet intuitive interface for managing their delivery receptacles. By allowing precise input of dimensions, flexible location labeling, real-time previews, and AI-powered scanning, this interface enhances the accuracy of fit assessments and strengthens the reliability of the entire pre-delivery assurance system. It places full control in the hands of the customer, encouraging proactive engagement and reducing the risk of failed deliveries due to size mismatches.

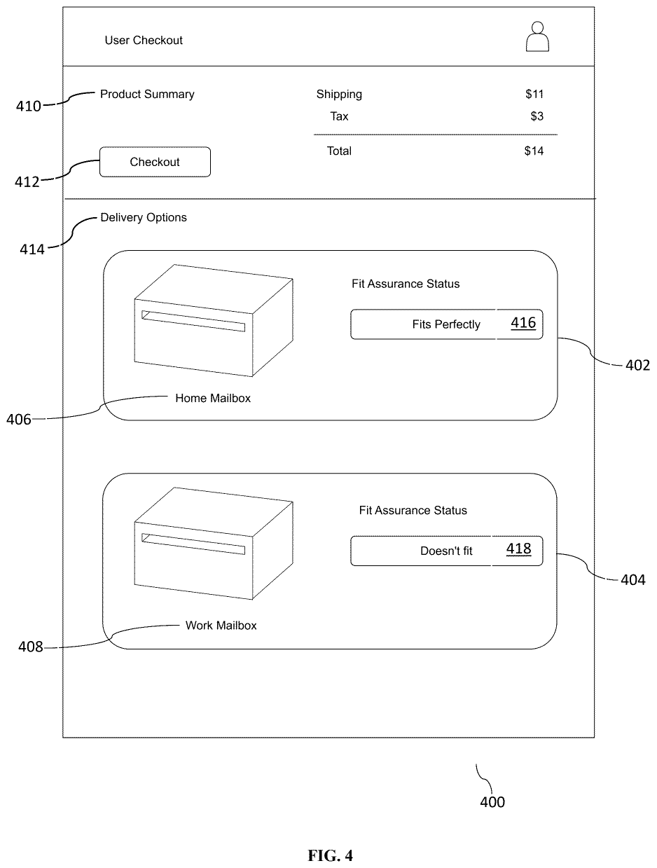

FIG. 4 illustrates a user checkout interface (400) that integrates the pre-delivery receptacle fit assurance system into an e-commerce platform's checkout process. This user interface is designed to help online shoppers make confident and informed decisions by providing real-time assurance on whether the items they are purchasing will fit into their preferred delivery receptacle—such as a home or office mailbox—before they complete the order. The layout is split into two main sections: the checkout summary and the delivery options panel.

The interface presents a standard “User Checkout” section (400) displaying a product summary section (410), which may include shipping costs, tax, and total. This setup mirrors familiar e-commerce workflows, ensuring user comfort without disrupting the shopping experience.

A Delivery Options panel (414) showcases available delivery destinations, which may include a list of receptacles, such as the “Home Mailbox” (406) and “Work Mailbox” (408), a clear visual image or icon is provided alongside a dynamic Fit Assurance Status indicator communicating to the customer whether the item they're purchasing will fit into the respective receptacle. In the example illustration, the Home Mailbox option (402) has a “Fits Perfectly” status (416), assuring the user of successful compatibility. Conversely, the Work Mailbox option (404) alerts the user with a “Doesn't fit” status (418), indicating dimensional incompatibility. A customer may proceed by selecting any receptacle with “Fits Perfectly” status and then click the “Checkout” button (412) to make a payment and place the order.

Overall, FIG. 4 integrates fit verification into the user's purchasing journey, providing a seamless and transparent way for users to ensure that their packages will be delivered securely and without delivery interruptions. By eliminating uncertainty and offering clear visual and textual cues, this interface enhances trust, reduces missed deliveries, and helps e-commerce platforms align logistics more closely with customer preferences and delivery infrastructure.

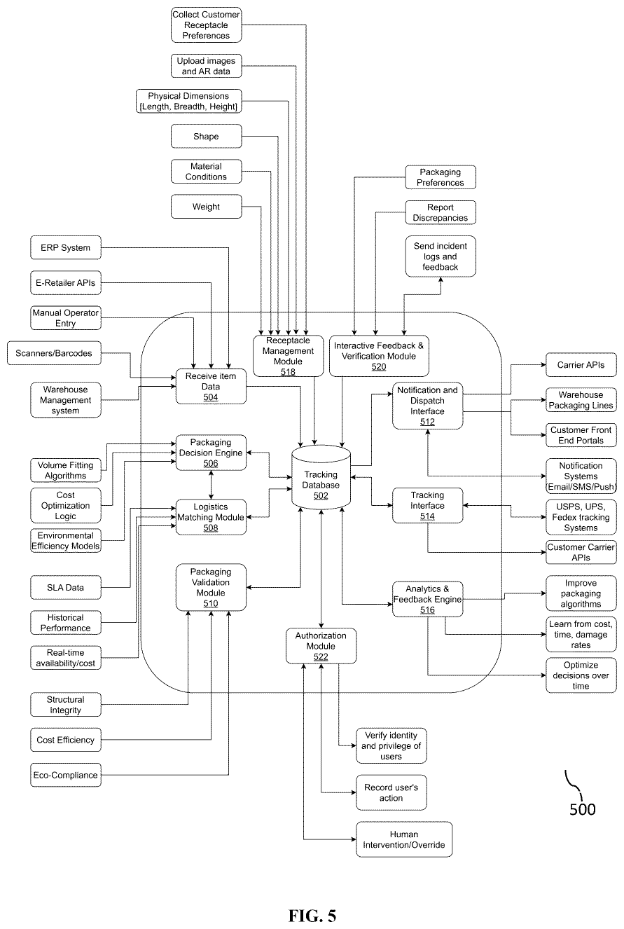

FIG. 5 illustrates the data flow within a pre-delivery receptacle fit assurance system (500), depicting its interaction with various tracking and data gathering systems, subsystems, and modules. This system is designed to manage the entire lifecycle of fit assurance validation, from initial data acquisition and processing to final delivery readiness, real-time notifications, and continuous post-delivery optimization. The various systems depicted in FIG. 5 may be implemented as systems stored and executed on pre-delivery receptacle fit assurance server (102), such as by software modules (114), or may be systems stored and executed on data repository (126). The systems, subsystems, and modules depicted in FIG. 5 provide a variety of data extraction and importation functionality allowing a user of the pre-delivery receptacle fit assurance to visualize the mailing process through aggregated inbound and outbound data, stored in a centralized Data Repository, herein referred to as Tracking Database (502), which forms the system's core, enabling robust data synchronization and dynamic communication among all interconnected components.

The Fit Assurance System (500) may consist of the Receive Item Data module (504), which functions as the system's primary input gateway for diverse item-related information and can query other systems for item information. This module is designed to collect various physical and logistical attributes, including but not limited to, item dimensions (e.g., length, breadth, height), structural characteristics (e.g., shape, material type), and mass (e.g., weight). Data can be sourced from a plurality of upstream systems, such as enterprise resource planning (ERP) systems, warehouse management platforms, automated scanning and identification systems (e.g., scanners and barcode readers), or manual input interfaces (Manual Operator Entry). Furthermore, the module is capable of processing advanced digital representations, such as Upload Images and AR scanning, to derive highly precise measurements and contextual information. Validated item data is then securely propagated to the Tracking Database (502) for ubiquitous access by all downstream processing elements.

The Fit Assurance System (500) may feature a Receptacle Management Module (518) designed as the control center for all user-centric receptacle configurations and dynamic preference management. Through user interfaces users can input (e.g., as illustrated in FIG. 3), modify, and manage detailed receptacle preferences, encompassing precise dimensions, critical operational attributes (e.g., non-locking door, access considerations), and nuanced location preferences, leveraging integrated mapping services (e.g., Google Maps). This module includes a real-time validation engine that checks submissions against feasibility, standards, and system constraints (e.g., legal placement limits), providing immediate feedback to prevent invalid entries and enhance user satisfaction. All validated configuration data is stored in the Tracking Database (502), serving as foundational input that directly informs subsequent automated validation and operational logic. This module thus establishes a robust framework that uniquely tailors pre-delivery fit assurances to customer needs and last-mile environments, maximizing delivery success, minimizing re-delivery costs, and profoundly enhancing customer satisfaction.

The Fit Assurance System (500) may include a Packaging Decision Engine (506) to determine optimal packaging configurations. This engine employs advanced computational algorithms and logical frameworks, such as Volume Fitting Algorithms for spatial optimization, Cost Optimization Logic for economic efficiency, and Environmental Efficiency Models for sustainability. It dynamically evaluates a comprehensive data set, including Historical data from the Tracking Database (502), SLA Data, Structural Integrity requirements, Cost Efficiency targets, and Eco-Compliance standards. The engine iteratively processes these inputs to propose and generate a highly detailed, actionable optimal packaging solution. This solution specifies optimal external dimensions, internal spatial arrangements, exact box dimensions, recommended material types (e.g., cardboard grade, protective inserts), and detailed packing protocols. The engine's output is a complete packaging blueprint, designed to maximize space utilization, ensure ecological compliance, adhere to carrier-specific regulations, and provide foundational specifications for downstream fulfillment, enabling granular control and continuous innovation in packaging strategies across the supply chain.

The Fit Assurance System (500) may also contain a Logistics Matching Module (508) that is engineered to identify the most suitable delivery carrier and logistical route. This determination is made by assessing a multitude of performance and cost parameters, including but not limited to, Historical Performance, Real-time availability/cost, SLA Data, and user-specified delivery receptacle. The derived logistical strategy is then intelligently cross-referenced with the selected packaging data from the Packaging Decision Engine (506) to ensure comprehensive compatibility.

The Fit Assurance System (500) may include a Packaging Validation Module (510) which consumes the output of both the Packaging Decision Engine (506) and Logistics Matching Module (508). This pivotal module is responsible for verifying the physical and structural compatibility of the chosen packaging with the user's designated receiving receptacle. It systematically accounts for various parameters, including dimensional tolerances and access restrictions, ensuring that the selected packaging is both robust enough to contain the item and capable of fitting securely within the user-specified receptacle, minimizing potential delivery issues.

The Fit Assurance System (500) may consist of the Notification and Dispatch Interface (512), a multi-channel communication tool designed to deliver real-time, actionable status updates across the logistical ecosystem. It strategically propagates a comprehensive array of data, including validated shipment details, precise package dimensions, confirmed receptacle fit status, and crucial handling directives, to diverse operational endpoints such as Carrier APIs (e.g., UPS®, FedEx®) for streamlined manifest generation and optimized routing. Concurrently, it dispatches granular packaging instructions, encompassing specified material types, exact box dimensions, and detailed packing protocols, directly to Warehouse Packaging Lines to ensure meticulous and accurate fulfillment. Furthermore, it engages directly with the end customer through various Customer Front End Portals and a full spectrum of communication channels, including email, SMS, and push notifications. These customer-centric communications extend beyond mere status updates to encompass proactive alerts regarding potential fit discrepancies (e.g., “Your package may be too large for your designated receptacle. Please update details or arrange an alternative.”), precise delivery window notifications, essential receptacle preparation reminders (e.g., “Please ensure your mailbox is clear for delivery of your item.”), critical delivery exception advisories (e.g., “There was an issue delivering to your receptacle; alternative arrangements required.”), and the provision of dynamic alternative delivery options in response to pre-dispatch or in-transit fit challenges. For instance, a user may receive notification that parcel dimensions have changed during transit, providing them with alternate delivery options such as “opting for a New receptacle” this updated preference can be stored in the Tracking Database (502), triggering a re-evaluation of the packaging fit by the Packaging Validation Module (510) and potentially initiating new notifications via the Notification and Dispatch Interface (512) if the fit status changes.

Fit Assurance System (500) may include a Tracking Interface (514) that serves as the primary means for managing dynamic external system integrations and comprehensive data exchange. This module is critically responsible for bidirectional interfacing with a multitude of third-party tracking services and logistical partners through sophisticated application programming interfaces (APIs), including but not limited to those provided by common parcel carriers (e.g., USPS, UPS, FedEx Tracking Systems). Beyond mere data ingestion, the Tracking Interface actively pulls real-time shipment progress, updated package dimensions, and any in-transit events (such as re-packaging or routing changes) into the central Tracking Database (502), thereby ensuring the system's internal data reflects the latest logistical realities. Crucially, if package dimensions or packaging type are altered or re-scanned during transit (e.g., due to re-packaging at a sorting hub, damage, or consolidation), the Tracking Interface (514) is designed to ingest these updated details and propagate them back to the Tracking Database (502). This triggers a re-evaluation of the packaging fit by the Packaging Validation Module (510) and potentially initiates new notifications via the Notification and Dispatch Interface (512) if the fit status changes, ensuring the system remains responsive to dynamic in-transit modifications. Concurrently, Tracking Interface (514) powers user-facing digital platforms, such as Customer Front End Portals, enabling customers to not only monitor their order status in real-time but also to ascertain if their package is projected to fit in their designated receptacle based on these continuously updated shipment dimensions.

The Fit Assurance System (500) may integrate an Interactive Feedback & Verification Module (520) as a critical channel for user engagement and continuous service improvement. This module actively collects granular, user-centric feedback, such as post-delivery ratings, direct reports of delivery discrepancies (e.g., mis-fits, damages), and specific receptacle access challenges via means of surveys, forms, etc. It may be designed to protect user data, ensuring compliance with privacy regulations like GDPR and CCPA, thereby fostering trust and secure participation. All user-provided feedback, incident logs, and verification data are immediately and persistently stored in the Tracking Database (502) and can be presented in formats such as the Logistic Fit Failure Report Table (234) and the User Fit Failure Report Table (236). This qualitative data serves as an invaluable supplement to adapting subsequent validation logic, operational strategies, and the continuous learning cycles of the system's core algorithms for the Packaging Decision Engine (506), Logistics Matching Module (508) and Packaging Validation Module (510). Ultimately, this module transforms passive delivery events into actionable intelligence, empowering the system to proactively identify and rectify service gaps, enhance algorithm accuracy, and foster an adaptive, user-responsive ecosystem prioritizing customer satisfaction and operational excellence.

The Fit Assurance System (500) may include an Analytics & Feedback Engine (516) responsible for systematically analyzing relevant data following delivery and the completion of each logistical cycle and routing relevant insights to the Tracking Database (502). This module aggregates and analyzes a vast spectrum of comprehensive performance data, encompassing detailed fit success/failure rates, reported damage rates, delivery time adherence, and overall cost-efficiency per shipment. Utilizing advanced data analytics and machine learning, the engine derives actionable insights that continuously refine and improve future algorithmic decisions for the Packaging Decision Engine (506), Logistics Matching Module (508) and Packaging Validation Module (510), including optimizing packaging logic, adjusting carrier preferences, and enhancing receptacle matching strategies. This powerful feedback loop of continuous learning from actual real-world outcomes transforms the system into a self-optimizing, intelligent network, ensuring sustained improvements in operational efficiency, cost reduction, and customer satisfaction by leveraging accumulated operational intelligence for adaptive evolution.

All critical system operations and sensitive data manipulations, encompassing modifications to receptacle details, overrides of automated packaging decisions, or manual adjustments to logistical strategies, are rigorously secured by the Authorization Module (522). This module serves as the central gateway for security and accountability, performing robust verification of user identity, assigned access levels, and requisite privileges prior to permitting any action. It is the fundamental component that enables secure human intervention and override capabilities, ensuring that operators with appropriate authorization can access internal interfaces to review, adjust, or re-evaluate outputs from modules like the Packaging Decision Engine (506), Logistics Matching Module (508) or Packaging Validation Module (510) in response to discrepancies, unique challenges, or specific requests. Furthermore, the Authorization Module logs every transaction and user action in the Tracking Database (502), thereby ensuring comprehensive auditing capabilities, regulatory compliance, and providing crucial, verifiable data to the Analytics & Feedback Engine (516) for continuous algorithmic refinement. This robust security framework underpins the system's flexibility and integrity, ensuring that all operations are secure, auditable, and contribute to an continuously learning and adaptable delivery network

Collectively, the pre-delivery receptacle fit assurance system (500) is an intelligent, self-optimizing platform that ensures packages are precisely sized for user-designated receptacles prior to delivery. By collecting real-time data on item attributes and receptacle specifications, the system employs advanced algorithms to determine optimal packaging and rigorously validate fit. It also features multi-channel user notifications and proactive intervention mechanisms, enabling users to address any issues promptly. Leveraging real-time processing, system-wide optimization, and continuous machine learning, the system revolutionizes logistical operations, guaranteeing that packages arrive ready for direct placement into intended receptacles. This minimizes risks such as misfits, costly rerouting, and delivery failures while maximizing operational efficiency and customer satisfaction.

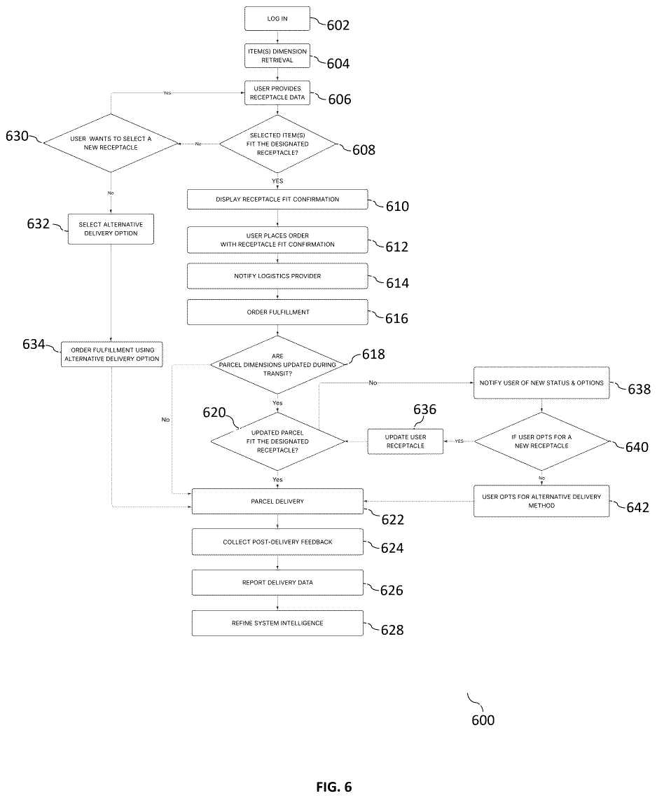

FIG. 6 is a flowchart representing an example process 600 of the use of pre-delivery receptacle fit assurance system, specifically regarding the dispatch of parcels in combination with a user's designated receptacle.

A customer may desire to receive an order consisting of single or multiple items to a designated receptacle. The customer may log into the system (step 602). This access may be authenticated and governed by the Authorization Module (522), which verifies user identity, applies role-based privileges, and enables secure access to fit assurance features.

Once authenticated, the Fit Assurance System (500) proceeds to retrieve item-specific dimensional data (step 604) via the Tracking Database (502). This occurs for the items the customer intends to purchase, allowing the system to determine optimal packaging configuration by invoking Packaging Decision Engine (506) and logistics compatibility by invoking Logistics Matching Module (508).

In the subsequent step 606, the user either selects an existing receptacle or provides new receptacle data, which is routed to and processed by the Receptacle Management Module (518). The receptacle data is then stored in the central Tracking Database (502).

Next, the system checks whether the selected items, once packaged, will fit into the user's designated receptacle at step 608. This determination may be conducted by the Packaging Validation Module (510), which consumes output from the packaging engines (506) and evaluates it against the receptacle data for structural and dimensional compatibility.

If the parcel is determined not to fit (‘No’ branch of step 608), the system, the system proceeds to step 630, prompting the user to select a different receptacle (e.g., a secondary mailbox or smart locker managed by the Receptacle Management Module 518). If the user declines a different receptacle, the process transitions to step 632, where the system offers alternative delivery methods (e.g., porch drop-offs, delivery to a neighbor, or pickup locations). Upon selection of an alternative delivery method, the system proceeds with order fulfillment via the selected alternative delivery path (step 634). Despite bypassing receptacle fit assurance in this branch, the system maintains operational continuity and customer satisfaction by ensuring the parcel reaches its destination through a practical and user-approved method.

Conversely, If the fit is validated, the system displays the receptacle fit confirmation (step 610) to the user, typically embedded into the checkout page UI (as shown in FIG. 4). The user then places the order (step 612), and the system automatically notifies the logistics provider (step 614) via the Notification & Dispatch Interface (512) the validated packaging and fitment data to carrier APIs and dispatches operational instructions to fulfillment teams, including box dimensions and material choices.

Once the order enters fulfillment (step 616), the system continues to monitor for packaging or routing modifications in real time via the Tracking Interface (514). If parcel dimensions remain stable throughout transit (‘No’ branch of step 618), the package proceeds directly to final delivery (step 622). However, if a repackaging event or dimensional change occurs (step 618), the Tracking Interface (514) updates the Tracking Database (502) with the new measurements and re-triggers the Packaging Validation Module (510) to reassess compatibility. The system checks whether the updated dimensions still allow the parcel to fit the original receptacle (step 620). If the parcel still fits, the process continues uninterrupted. If not, a decision fork is triggered.

In cases of in-transit parcel and receptacle incompatibility (‘No’ branch of step 620), the system notifies the user (step 638) via the Notification & Dispatch Interface (512) offering actionable resolutions such as providing an alternate receptacle, or selecting an alternative delivery methods (e.g., porch drop-offs, delivery to a neighbor, or pickup locations).

If the user declines a different receptacle, the process transitions to step 642, where the user selects alternative delivery methods (e.g., porch drop-offs, delivery to a neighbor, or pickup locations). Upon selection of an alternative delivery method, the system proceeds with final delivery (step 622).

Conversely, If the user provides a new delivery receptacle, user's receptacle is updated in the Tracking Database (502) at step 636 and a parcel fit compatibility with the updated receptacle is re-evaluated at step 620 by triggering the Packaging Validation Module (510).

If a parcel is determined to be delivered in the user's receptacle (‘Yes’ branch of step 620), the parcel is delivered to the receptacle (step 622). Post delivery the system initiates feedback capture (step 624) via the Interactive Feedback & Verification Module (520) from customer and delivery personnel as collected for the Logistic Fit Failure Report Table (234) and User Fit Failure Report Table (236).

The collected data is stored securely in the Tracking Database (502) at step 626. At step 628 the collected data is fed to the Analytics & Feedback Engine (516) applying data analytics and machine learning to continuously optimize algorithmic decisions within the Packaging Decision Engine (506), Logistics Matching Module (508), and Packaging Validation Module (510)—refining packaging logic, improving carrier and receptacle matching, and reducing future delivery failures. These refinements complete a powerful feedback loop, transforming real-world operational data into strategic improvements that enhance the accuracy, efficiency, and adaptability of the system.

In summary, FIG. 6 encapsulates a living, intelligent delivery assurance workflow, powered by tightly integrated modular subsystems described in FIG. 5. The system's architecture enables dynamic packaging validation, proactive exception handling, and user-driven decision-making—all governed by robust security and real-time feedback mechanisms. Through these layers, the pre-delivery receptacle fit assurance system ensures that every package is intelligently assessed for receptacle compatibility, reducing misfits and re-routes while empowering customers and delivery networks with precision, transparency, and control.

In summary, the invention presents a comprehensive and intelligent solution for pre-validating whether parcels will fit into delivery receptacles. It introduces a proactive mechanism into the delivery chain that reduces failure rates, enhances customer experience, and contributes to the broader goal of smarter, data-driven logistics.

It should be understood that the examples provided herein are merely illustrative and are not exhaustive or limited to the precise forms disclosed. Various combinations, adaptations, substitutions, and modifications can be made by those skilled in the art without departing from the spirit and scope of the invention as claimed. Importantly, the described invention can be practiced in the absence of any particular element if not essential to a specific embodiment.

While specific examples of processes or apparatuses are described, the scope of the accompanying claims is broader and encompasses other equivalent processes or apparatuses.

1. A method for pre-delivery receptacle fit assurance, wherein the method executed by the computing system comprises:
enabling, a user to select one or more items for purchase;
receiving, item dimensional data for the one or more selected items;
receiving, receptacle dimensional data for a designated delivery receptacle;
calculating, packaging dimensions for a parcel based on the received item dimensional data and packaging constraints;
simulating, a physical fit of the parcel within the designated delivery receptacle based on the calculated packaging dimensions and the received receptacle dimensional data;
generating, a fit assurance status indicating whether the parcel is predicted to fit within the designated delivery receptacle;
outputting, the fit assurance status for display at a graphical user interface associated with an application;
storing, data related to the parcel, the receptacle, the fit assurance status, and the associated order transaction in a data repository;
transmitting, delivery instructions to a logistics provider based on the fit assurance status;
monitoring, parcel condition during fulfillment and transit, including dimensional changes;
updating, the fit determination in response to dimensional changes detected during transit;
prompting, a user for selection of a new receptacle or an alternative delivery option if the parcel is predicted not to fit or if dimensional changes affect fit;
receiving, user input selecting either a new receptacle or an alternate delivery method;
executing, order fulfillment using the validated receptacle or alternate delivery path;
collecting, post-delivery feedback regarding actual delivery outcomes; and
providing, analytics based on the stored data and collected feedback.

2. The method of claim 1, wherein receiving item dimensional data for one or more items comprises at least one of: manual entry, barcode scanning, three-dimensional optical scanning, or augmented reality imaging.

3. The method of claim 1, wherein receiving receptacle dimensional data comprises at least one of: user manual input, artificial-intelligence based analysis of uploaded receptacle images, or real-time data from an internet of things enabled smart receptacle.

4. The method of claim 1, wherein the simulation accounts for at least one of: multiple parcel orientations, clearance tolerances, packaging configurations, or non-locking door dimensions of the receptacle.

5. The method of claim 1, further comprising enabling the user to select an alternative delivery option if the parcel does not fit in the selected receptacle, wherein the alternative delivery option includes at least one of: locker delivery, hold-for-pickup designation, selection of an alternate pre-registered receptacle, scheduled delivery, directed delivery to a specific location, alternative location delivery, signature required delivery, identity verification delivery, or photo proof of delivery.

6. The method of claim 1, wherein modified parcel dimensions are received during transit via a tracking interface integrated with at least one or more third-party logistics application programming interface.

7. The method of claim 1, wherein the post-delivery feedback includes logistics-reported fit discrepancies or user-reported fit discrepancies or successful fit confirmations.

8. A computing system for pre-delivery receptacle fit assurance, the system comprising:
a computer-readable storage medium storing instructions; and
at least one processor, wherein the memory comprises instructions which, when executed by the at least one processor, cause the computing system to: enable a user to select one or more items for purchase;
receive item dimensional data for the one or more selected items;
receive receptacle dimensional data for a designated delivery receptacle;
calculate packaging dimensions for a parcel based on the received item dimensional data and packaging constraints;
simulate a physical fit of the parcel within the designated delivery receptacle based on the calculated packaging dimensions and the received receptacle dimensional data;
generate a fit assurance status indicating whether the parcel is predicted to fit within the designated delivery receptacle;
output the fit assurance status for display at a graphical user interface associated with an application;
store data related to the parcel, the receptacle, the fit assurance status, and the associated order transaction in a data repository;
transmit delivery instructions to a logistics provider based on the fit assurance status;
monitor parcel condition during fulfillment and transit, including dimensional changes;
update the fit determination in response to dimensional changes detected during transit;
prompt a user for selection of a new receptacle or an alternative delivery option if the parcel is predicted not to fit or if dimensional changes affect fit;
receive user input selecting either a new receptacle or an alternate delivery method;
execute order fulfillment using the validated receptacle or alternate delivery path;
collect post-delivery feedback regarding actual delivery outcomes; and
provide analytics based on the stored data and collected feedback.

9. The computing system of claim 8, wherein the system is configured to receive item dimensional data for one or more items comprising at least one of: manual entry, barcode scanning, three dimensional optical scanning, or augmented reality imaging.

10. The computing system of claim 8, wherein the system is configured to receive receptacle dimensional data comprising at least one of: user manual input, artificial intelligence based analysis of uploaded receptacle images, or real-time data from an internet of things enabled smart receptacle.

11. The computing system of claim 8, wherein the system is configured to simulate a physical fit of the parcel accounting for at least one of: multiple parcel orientations, clearance tolerances, packaging configurations, or non-locking door dimensions of the receptacle.

12. The computing system of claim 8, wherein the system is configured to enable the user to select an alternative delivery option if the parcel does not fit in the selected receptacle, wherein the alternative delivery option includes at least one of: locker delivery, hold-for-pickup designation, selection of an alternate pre-registered receptacle, scheduled delivery, directed delivery to a specific location, alternative location delivery, signature required delivery, identity verification delivery, or photo proof of delivery.

13. The computing system of claim 8, wherein the system is configured to receive modified parcel dimensions during transit via a tracking interface integrated with one or more third-party logistics application programming interfaces.

14. The computing system of claim 8, wherein the system is configured to collect post-delivery feedback including logistics-reported fit discrepancies or user-reported fit discrepancies or successful fit confirmations.

15. A non-transitory computer-readable storage medium encoded with instructions that, when executed by at least one processor of a computing device, cause the at least one processor to perform a method by the computing system comprising:
enabling, a user to select one or more items for purchase;
receiving, item dimensional data for the one or more selected items;
receiving, receptacle dimensional data for a designated delivery receptacle;
calculating, packaging dimensions for a parcel based on the received item dimensional data and packaging constraints;
simulating, a physical fit of the parcel within the designated delivery receptacle based on the calculated packaging dimensions and the received receptacle dimensional data;
generating, a fit assurance status indicating whether the parcel is predicted to fit within the designated delivery receptacle;
outputting, the fit assurance status for display at a graphical user interface associated with an application;
storing, data related to the parcel, the receptacle, the fit assurance status, and the associated order transaction in a data repository;
transmitting, delivery instructions to a logistics provider based on the fit assurance status;
monitoring, parcel condition during fulfillment and transit, including dimensional changes;
updating, the fit determination in response to dimensional changes detected during transit;
prompting, a user for selection of a new receptacle or an alternative delivery option if the parcel is predicted not to fit or if dimensional changes affect fit;
receiving, user input selecting either a new receptacle or an alternate delivery method;
executing, order fulfillment using the validated receptacle or alternate delivery path;
collecting, post-delivery feedback regarding actual delivery outcomes; and
providing, analytics based on the stored data and collected feedback.

16. The non-transitory computer-readable storage medium of claim 15, wherein receiving item dimensional data for one or more items comprises at least one of: manual entry, barcode scanning, three-dimensional optical scanning, or augmented reality imaging.

17. The non-transitory computer-readable storage medium of claim 15, wherein receiving receptacle dimensional data comprises at least one of: user manual input, artificial-intelligence based analysis of uploaded receptacle images, or real-time data from an internet of things enabled smart receptacle.

18. The non-transitory computer-readable storage medium of claim 15, wherein the simulation accounts for at least one of: multiple parcel orientations, clearance tolerances, packaging configurations, or non-locking door dimensions of the receptacle.

19. The non-transitory computer-readable storage medium of claim 15, further comprising instructions enabling the user to select an alternative delivery option if the parcel does not fit in the selected receptacle, wherein the alternative delivery option includes at least one of: locker delivery, hold-for-pickup designation, selection of an alternate pre-registered receptacle, scheduled delivery, directed delivery to a specific location, alternative location delivery, signature required delivery, identity verification delivery, or photo proof of delivery.

20. The non-transitory computer-readable storage medium of claim 15, wherein modified parcel dimensions are received during transit via a tracking interface integrated with one or more third-party logistics application programming interface.
